(19) United States
(12) Patent Application Publication
(10) Pub. No.: US 2022/0084520 A1
(43) Pub. Date: Mar. 17, 2022

(54) SPEECH-RESPONSIVE CONSTRUCTION TOOL

(71) Applicant: BLACK & DECKER INC., New Britain, CT (US)

(72) Inventors: Daniel J. White, Baltimore, MD (US); Andrew E. Seman, JR., Pylesville, MD (US); Antony Orsini, Cheshire, CT (US); Paul E. Becke, Stewartstown, PA (US)

(21) Appl. No.: 17/455,762

(22) Filed: Nov. 19, 2021

Related U.S. Application Data
(63) Continuation of application No. PCT/US2020/033396, filed on May 18, 2020.
(60) Provisional application No. 62/850,213, filed on May 20, 2019.

(51) Int. Cl. G10L 15/22; G10L 15/28

(52) U.S. Cl. CPC G10L 15/22; G10L 15/28

(57) ABSTRACT

A construction tool has a housing, a processor disposed within the housing, a microphone disposed within the housing, the microphone capturing speech uttered by a user, speech services module connected to the processor for interpreting the speech, the speech services module providing instructions to the processor in response to the interpreted speech, and a speaker disposed within the housing. The construction tool is electrically connectable to a power tool, a hand tool, and/or a non-motorized sensing tool. The speech services module may be disposed within the housing. Alternatively, the speech services module may be located in a remote server accessed via a wireless communications interface.

### FIELD OF INVENTION

The present invention relates to a construction tool and more particularly a speech-responsive construction tool that can be connected to a power tool, hand tool or distance measuring device, or used independently.

### BACKGROUND OF THE INVENTION

It is desirable to rapidly and efficiently modify attributes of power tools to better match the jobsite application. For example, it may be preferable to change the blade speed in a circular saw in order to better cut a particular material. US Publication No. 2014/0107853, which is hereby fully incorporated by reference, teaches a power tool, a power tool battery pack, a power tool battery pack charger, a non-motorized sensing tool and/or a portable power source can be provided with a communication circuit to enable such devices to communicate and interact with a computing device, which would allow for the quick modification of attributes for such devices.

Because such computing device typically requires the user to look at it for operation, it can distract the user from the jobsite task. Accordingly, it is desirable to provide a construction tool that would not require the user to look at it for operation.

### DESCRIPTION OF THE DRAWINGS

Preferred embodiments of the invention will now be described, by way of example, with reference to the accompanying drawings, of which:

FIG. 1 is a system diagram of a computer network including a construction tool;

FIG. 2 is a rear view of the construction tool of FIG. 1;

FIG. 3 is a block diagram showing the components of the construction tool of FIG. 1;

FIG. 4 is a block diagram showing the construction tool of FIG. 1 being used with the support of a speech support service server; and

FIG. 5 is a flowchart of different exemplary process that can be performed by the system.

### DETAILED DESCRIPTION

A construction tool may be configured in conjunction with a network-based speech support service server to implement a speech interface and to perform actions in response to spoken user commands.

The construction tool preferably has a talk button that the user presses when speaking a command. While the talk button is pressed, the construction tool captures user audio and provides the user audio to the speech support service server. The speech support service server performs automatic speech recognition (ASR) and natural language understanding (NLU) to determine the action desired by the user. Upon identifying the desired action, the construction ptool or another component connected to and/or controlled by the construction tool can enable the action to occur.

The construction tool may have a rechargeable battery so that the device can be used without connection to an external power source. However, the device may also be connected to an external power source that provides external electrical power for battery recharging.

When the construction tool is receiving external power, the device may activate enhanced capabilities. As an example, the construction tool may itself may have speech processing capabilities, such as wakeword detection, ASR, and/or NLU, that are activated only when the device is receiving power from an external source. As a more specific example, the device may use wakeword detection when docked and receiving external power, so that the user is not required to press the talk button in order to direct speech to the device. Rather, the construction tool continually monitors sound within its environment, detects a user utterance of a wakeword, and subsequently captures user audio and provides the user audio to the speech support service server for further analysis.

As another example, the device may activate device-supported ASR features when receiving external power and may respond to certain types of user speech without relying on network-based speech support services, which may at times introduce undesirable latencies.

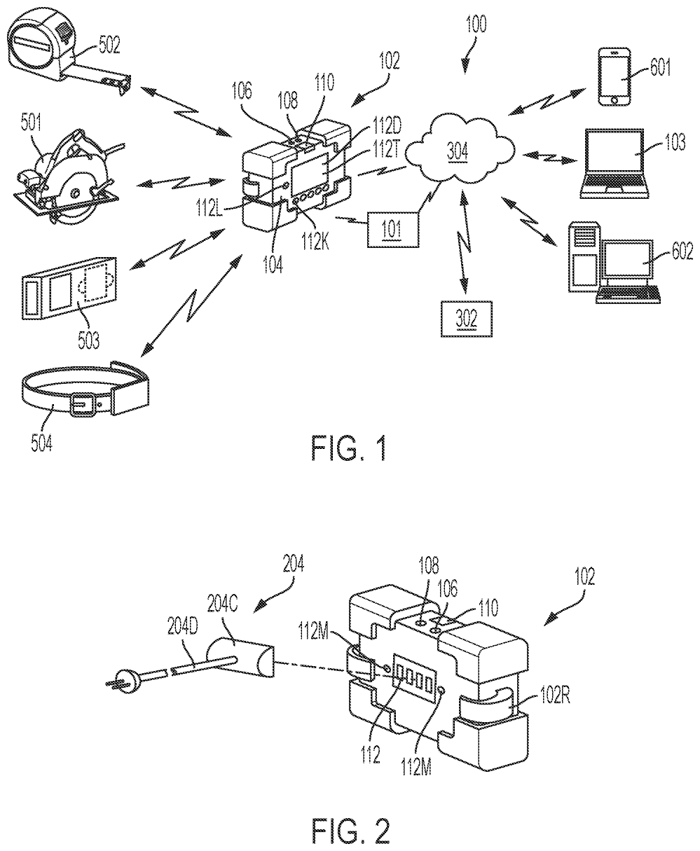

FIGS. 1-2 shows an example construction tool 102. The construction tool 102 comprises a housing 104 that supports one or more microphone(s) 106, one or more speakers 108, and a talk button 110. The talk button 110 may also be referred to as a talk actuator or a push-to-talk (PTT) button. The construction tool 102 may have knobs and/or buttons 112K or other controls in addition to the talk button 110, such as a power button, volume buttons, directional-navigation control buttons (such as UP, DOWN, LEFT and/or RIGHT buttons), an ENTER button, etc. In some cases, the construction tool 102 may have LEDs or lights 112L and/or a graphics display 112D for presentation of information to the user. Display 112D may include a touch screen input 112T. Persons skilled in the art shall recognize that a touch screen input 112T may be provided in addition to the touch screen input of display 112D and/or adjacent to display 112D. LEDs or lights 112L may also be used to illuminate a work surface.

The construction tool 102 may be designed and configured to rest horizontally on a surface, with the speakers 108 facing a user. In addition, the construction tool 102 may be designed for handheld use during which a user holds the construction tool 102 and speaks into the microphone 106 while pressing the talk button 110. The construction tool 102 may be configured so that the talk button 110 is easily accessed by a user's thumb when holding the construction tool 102 near the user's mouth.

Preferably talk button 110 is near or adjacent to microphone 106. In this manner, a slidable talk button 110 may be provided that can be moved between two positions: a first position where microphone 106 is covered and a second position where microphone 106 is uncovered. In the first position, microphone 106 will be protected from the elements. If the user wants to uncover microphone 106 for use, the user would only need to slide talk button 110 to the second position.

The microphone(s) 106 may be selected and/or designed for sensitivity to near-field audio so as to capture user speech when the microphone 106 is held near the mouth of the user. The microphone 106 generates an audio signal that contains the user speech. Additional microphones may be utilized to analyse background noise from different angles for the purpose of noise cancellation. The additional microphones could also determine the originating location of the speech. Such information can be used to determine time of flight information. In addition, by determination the origin of such speech, the construction tool 102 can determine whether the speech is originating from the direction normally associated with the user of the device. Such information can be used to eliminate speech input received from other non-users.

Construction tool 102 may be attached to a garment, such as a vest or belt 504.

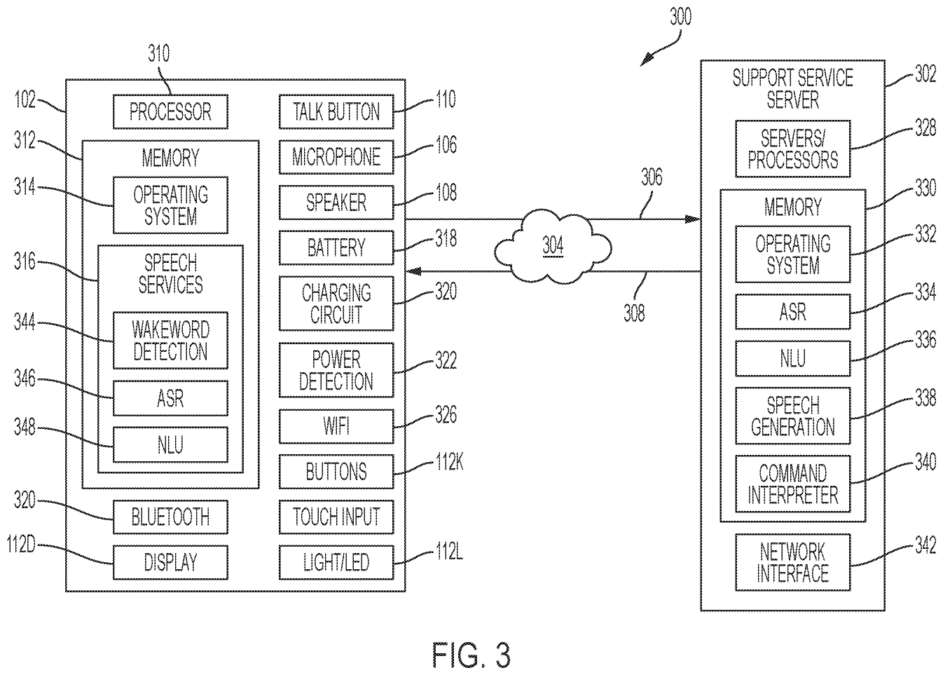

The construction tool 102 may be powered by a rechargeable internal battery (318 in FIG. 3) for cordless operation. The construction tool 102 may have contacts or ports 112 that can receive external power by means of a charging dock or cradle in order to charge the internal battery and/or to operate from household power mains.

Alternatively, construction tool 102 may be disposed on and electrically connected to a power tool 501, a hand tool (such as tape measure 502), or a non-motorized sensing tool (such as distance measuring tool 503), via contacts 112. Connecting construction 102 to power tool 501, tape measure 502, distance measuring tool 503, etc. may preferably enhanced capabilities. For example, persons skilled in the art will recognize that power tool 501, hand tool (such as tape measure 502), or non-motorized sensing tool (such as distance measuring tool 503) may have a memory or other resource containing data. Such memory can store previous measurements, sensed positions, etc. Preferably the power tool 501, hand tool (such as tape measure 502), and/or non-motorized sensing tool (such as distance measuring tool 503) have a data port or contacts that would connected with contacts 112 to allow construction tool 102 to query and/or transfer data to and/or from power tool 501, hand tool (such as tape measure 502), and/or a non-motorized sensing tool (such as distance measuring tool 503). Preferably construction tool 102 may also receive power via contacts 112 to charge rechargeable battery 318.

Preferably construction tool 102 may have retainers 102R pivotally attached to housing 104. Preferably retainers 102R will be spring-biased towards a retaining position that can engage features on power tool 501, hand tool (such as tape measure 502), or a non-motorized sensing tool (such as distance measuring tool 503), and ensure proper contact between data ports on such power tool 501, hand tool (such as tape measure 502), and/or the non-motorized sensing tool (such as distance measuring tool 503) and contacts 112. Persons skilled in the art shall recognize that retainers 102R may be designed so that construction tool 102 is permanently attached to the power tool 501, tape measure 502, distance measuring tool 503, etc.

Construction tool 102 may be connected to a power source via a power cable 204. Power cable 204 may include a connector 204C for connecting to the contacts 112, and a cable 204D electrically connecting the connector 204C to an external power source such as a power mains or a direct-current (DC) adapter that is connected to the power mains. For example, a DC adapter may connect to a 110 volt alternating current (AC) power mains and may produce DC power in the range of 1.1 to 126 volts, and preferably 5 to 20 volts. An adapter such as this may be referred to as an AC-DC adapter. The DC power is provided through the cable 204D to the connector 204C, which is preferably configured to provide the external DC power to the construction tool 102 through the contacts 112 of the construction tool 102. Persons skilled in the art shall recognize that at least one of power cable 204 and construction tool 102 may have at least one magnet 112M for magnetically coupling the power cable 204 to construction tool 102.

The construction tool 102 and accompanying power cable 204 shown in FIGS. 1 and 2 are examples of many possible physical configurations, which may include different shapes, different components, and different component placements. In some embodiments, the construction tool 102 may have buttons or other controls in addition to the talk button 110, such as a power button, volume buttons, navigation control buttons, etc. In some cases, the construction tool 102 may have a graphics display 112D for presentation of information to the user. The construction tool 102 may also have communications ports and/or electrical connections that are not shown.

The construction tool 102 is preferably configured to capture and respond to user speech. For example, the user may verbally dictate a note (such as a measurement) to be shown by the construction tool 102 on a display. The construction tool 102 preferably responds to the request by transcribing the user speech and showing the transcribed speech on the display 112D. In certain situations, the user may need to press the talk button 110 when speaking a request.

In other cases, the user may indicate a request by prefacing the request with a predefined keyword, which is also referred to herein as a wakeword or trigger expression. More specifically, the construction tool 102 may rely on the talk button to detect spoken user requests when the construction tool 102 is operating from battery power and may enable wakeword detection only when the construction tool 102 is receiving external power. Disabling wakeword detection when operating on battery power reduces computational activities and power consumption, thereby increasing battery life.

Persons skilled in the art will recognize that construction tool 102 may be awakened without a wakeword or talk button press if construction tool 102 receives a signal via contacts 112.

The construction tool 102 may be supported by network-based services such as speech support services that perform ASR and NLU on audio captured by the microphone 106 and that provide instructions to the construction tool 102 in response to recognized speech. This allows relatively sophisticated audio and speech processing to be performed despite limited processing capabilities of the construction tool 102 itself.

In some cases, however, the construction tool 102 may have at least limited speech recognition capabilities that are activated and utilized when the construction tool 102 is receiving external power or when the state of charge of rechargeable battery 318 is equal to or higher than a predetermined threshold. In various embodiments, different levels of speech support may be provided by the construction tool 102 when receiving external power, such as ASR, NLU, and speech synthesis. Performing these functions locally avoids delays and latencies that may otherwise be introduced by interacting with network-based services.

For example, in one operation mode, referred to herein as a voice control mode, the construction tool 102 implements a speech interface through which the user selects an action for the construction tool 102 by speaking commands to the construction tool 102. In some embodiments, the voice control mode is used only during those times during which the construction tool 102 has broadband Internet connectivity

When operating in the voice control mode, the user speaks a verbal command into the microphone 106 while actuating the talk button 110. The user speech is analyzed and interpreted to identify the action desired by the user. Once such action is identified, the construction tool 102 can implement the desired action. During times when the construction tool 102 is receiving external power, the user may preface a verbal command with a wakeword and may not need to press the talk button 110.

The identified actions may be played on the speakers 108 and/or displayed on display 112D of the construction tool 102. However, the construction tool 102 may also be configured to control, send information to and/or request information from other devices, such as local devices 601 (such as smartphones, personal media devices, Bluetooth speakers), central server 103, computer 602, data display terminal, etc. or other speaker peripherals that are nearby.

FIG. 3 shows an example system 300 of which the construction tool 102 may be a part. The system includes the construction tool 102 and a network-accessible speech support service server 302. Persons skilled in the art are referred to U.S. Pat. No. 9,558,740 (entitled “Disambiguation in speech recognition” and issued on Jan. 31, 2017), U.S. Pat. No. 9,424,840 (entitled “Speech recognition platforms” and issued on Aug. 23, 2016) and U.S. Pat. No. 9,633,661 (entitled “Speech-responsive portable speaker” and issued on Apr. 25, 2017), which are fully incorporated herein by reference, for further information on system 300 and speech support service server 302. The speech support service server 302 may be implemented as a network-based or cloud-based service that is located remotely or external to the construction tool 102. For example, the speech support service server 302 may be implemented by a business organization and/or service provider to support multiple construction tools 102 that are located in different user premises, which in turn may be located in widely varying geographic locations.

The speech support service server 302 may in some instances be part of a network-accessible computing platform that is maintained and accessible via a wide-area network 304 such as the Internet. Network-accessible computing platforms such as this may be referred to using terms such as “on-demand computing”, “software as a service (SaaS)”, “platform computing”, “network-accessible platform”, “cloud services”, “data centers”, and so forth.

Communications between the construction tool 102 and the speech support service server 302 may be implemented through one or more data communication networks, including local-area networks, wide-area networks, and/or the public Internet. Cellular and/or other wireless data communications technologies may also be used to communicate with the speech support service server 302. User premises may include local network support equipment to facilitate communications with the speech support service server 302, such as wireless access points, network routers, communication hubs, etc.

In operation, the construction tool 102 provides an audio signal 306 to the speech support service server 302 in response to a user of the construction tool 102 pressing the talk button 110. The speech support service server 302 analyzes the audio signal 306 to detect user speech, to determine the meaning of the user speech, and to provide a response signal 308 that contains or indicates an appropriate response to the meaning of the user speech. The response signal 308 may indicate actions or functions that the construction tool 102 is to perform. Alternatively, or in addition, the response signal 308 may comprise an audio signal containing audio that is to be rendered by the construction tool 102. For example, the audio may comprise generated speech or requested audio content such as music.

The construction tool 102 has operational logic, which in the illustrated example comprises a processor 310 and associated memory 312. The processor 310 may include multiple processors and/or a processor having multiple cores. The processor 310 may comprise processor extensions, co-processors, digital signal processors, fpga/combination logic and so forth.

The memory 312 may contain applications and programs in the form of computer-executable instructions that are executed by the processor 310 to perform acts or actions that implement desired functionality of the construction tool 102, including the functionality described herein. The memory 312 may be a type of computer storage media and may include volatile and nonvolatile memory. The memory 312 may include, but is not limited to, RAM, ROM, EEPROM, flash memory, or other memory technology.

Memory 312 can also have an ID code for construction tool 102. This would enable the system to send data or messages to construction tool 102 and/or other items in the network directly to the desired recipient, rather than sending the data/messages to all items on the network.

FIG. 3 shows examples of applications and/or programs that may be provided by the construction tool 102 and stored by the memory 312 to implement functionality of the construction tool 102, although many other applications and types of functionality may be provided in various embodiments.

The construction tool 102 may have an operating system 314 that is configured to manage hardware and services within and coupled to the construction tool 102 and to implement the general functionality of the construction tool 102 as described herein. In some embodiments, the memory 312 may also contain programs or applications that implement local speech services 316, which may be used during times when the construction tool 102 is connected to an external power source such as when the device is placed in the power cable 204. The nature and use of the local speech services 316 will be explained in more detail below.

As already described, the construction tool 102 has one or more microphone(s) 106, one or more speakers 108, a talk button 110, and a rechargeable battery 318. In addition, the construction tool 102 has a charging circuit 320 that receives electrical power from an external source such as a power mains, an AC-to-DC converter connected to the power mains, or an external DC source. The charging circuit 320 is configured to charge the rechargeable battery 318 when the construction tool 102 receives external power.

The construction tool 102 may also have a power detector 322 that detects when the construction tool 102 is receiving external electrical power and/or when the construction tool 102 is charging the rechargeable battery 318. The power detector 322 may be configured to produce a signal to indicate that the construction tool 102 is receiving external power and is charging the rechargeable battery 318. In some embodiments, the charging detection circuit may comprise a voltage detector configured to detect the presence of a DC voltage at the contacts 112 of the construction tool 102.

The construction tool 102 may have a device-to-device wireless communications interface, which in the illustrated embodiment comprises a Bluetooth® personal-area-networking (PAN) interface 324. The Bluetooth interface 324 may be used by the construction tool 102 to communicate with local devices 601 such as smartphones, personal media devices, and other content sources or audio peripherals.

The construction tool 102 may also have a wireless wide-area network (WAN) communications interface such as a WiFi® interface 326. The WiFi interface 326 may be configured to communicate over the wide-area network 304 with the speech support service server 302. More generally, the construction tool 102 and/or the speech support service server 302 may communicatively couple to the wide-area network 304 via radio frequency (RF), cellular, mobile telephone networks, satellite, Bluetooth®, Wi-Fi, or other connection technologies. The network 304 is representative of any type of communication network, including data and/or voice network, and may be implemented using wired infrastructure (e.g., coaxial cable, fiber optic cable, etc.), a wireless infrastructure (e.g., RF, cellular, microwave, satellite, Bluetooth®, Wi-Fi, etc.), and/or other connection technologies.

The speech support service server 302 comprises operational or control logic, which may comprise one or more servers, computers, and/or processors 328 and associated memory 330 containing applications and programs in the form of instructions that are executed by the servers, computers, or processors 328 to perform acts or actions that implement desired functionality of the speech support service server 302, including the functionality specifically described herein. The memory 330 may be a type of computer storage media and may include volatile and nonvolatile memory. Thus, the memory 330 may include, but is not limited to, RAM, ROM, EEPROM, flash memory, or other memory technology. In certain implementations, the speech support service server 302 may comprise a plurality of servers configured to support and communicate with multiple construction tools 102 over the Internet.

The speech support service server 302 may have an operating system 332 that is configured to manage components and services of the speech support service server 302. Among other software components that are not shown, the speech support service server 302 may include an automatic speech recognition (ASR) service 334 that recognizes human speech in an audio signal provided by the construction tool 102 from the microphone 106. Software of the speech support service server 302 may also include a natural language understanding (NLU) service 336 that determines user intent based on user speech that is recognized by the ASR service 334.

The ASR service 334 may use various techniques to create a transcript of spoken words represented in an input audio signal. For example, the ASR service 334 may reference various types of models, such as acoustic models and language models, to recognize words of speech that are represented in an audio signal. In some cases, models such as these are created by training, such as by sampling and manually classifying many different types of speech.

An acoustic model may represent speech as a series of vectors corresponding to features of an audio waveform over time. The features may correspond to frequency, pitch, amplitude, and time patterns. Statistical models such as Hidden Markov Models (HMMs) and Gaussian mixture models may be created based on large sets of training data. Models of received speech are then compared to models of the training data to find matches.

Language models describe things such as grammatical rules, common word usages and patterns, dictionary meanings, and so forth, to establish probabilities of word sequences and combinations. Analysis of speech using language models may be dependent on context, such as the words that come before or after any part of the speech that is currently being analyzed.

ASR may provide recognition candidates, which may comprise words, phrases, sentences, or other segments of speech. The candidates may be accompanied by statistical probabilities, each of which indicates a “confidence” in the accuracy of the corresponding candidate. Typically, the candidate with the highest confidence score is selected as the output of the speech recognition.

The NLU service 336 analyzes a word stream provided by the ASR service 334 and produces a representation of a meaning of the word stream. For example, the NLU service 336 may use a parser and associated grammar rules to analyze a sentence and to produce a representation of a meaning of the sentence in a formally defined language that conveys concepts in a way that is easily processed by a computer. For example, the meaning may be semantically represented as a hierarchical set or frame of slots and slot values, where each slot corresponds to a semantically defined concept. Thus, the meaning of the sentence may be semantically represented by the frame of slots and slot values. NLU may also use statistical models and patterns generated from training data to leverage statistical dependencies between words in typical speech.

Software elements of the speech support service server 302 may further comprise a speech generation service 338 that synthesizes or otherwise produces speech audio. For example, the speech generation service 338 may comprise a text-to-speech (TTS) component that produces speech from text to produce speech messages to be played at the construction tool 102.

Software of the speech support service server 302 may also comprise a command interpreter and action dispatcher 340 (referred to herein simply as a command interpreter 340) that determines functions or commands corresponding to user intents. In some cases, commands may correspond to functions that are to be performed at least in part by the construction tool 102, and the command interpreter 340 may in those cases provide commands to the construction tool 102 for implementing such functions. Examples of commands or functions that may be performed by the construction tool 102 in response to directives from the command interpreter 340 include conducting calculations (such as length comparisons, calculated volumes, etc.), displaying measurements and/or notes on display 112D, playing music or other media, increasing/decreasing the volume of the speakers 108, generating audible speech through the speakers 108, and so forth.

The speech support service server 302 may also comprise a network interface 342 configured to communicate with the construction tool 102 over the wide-area network 304.

In some cases the speech support service server 302 may conduct dialogs with a user of the construction tool 102 to determine the intent of a user. Generally, a speech dialog comprises a sequence of speech questions, answers, and/or statements pertaining to a particular action or intent of the user. More specifically, a speech dialog may comprise a series of speech expressions that may include utterances by the user and speech messages generated by the speech support service server 302. A speech dialog, for example, may begin upon an initial user utterance. The speech support service server 302 may respond with a speech message, such as “what do you want to do?” The user may respond by making a statement in answer to the question. This process may iterate until the speech support service server 302 is able to determine a specific action to take or function to invoke. In the implementation of FIG. 3, the speech expressions are conveyed as audio signals between the construction tool 102 and the speech support service server 302. Persons skilled in the art shall recognize that such dialog may also be performed with text script shown on display 112D.

In embodiments described herein, the construction tool 102 is designed to execute actions in response to commands spoken by a user. For example, the user might press the talk button 110 and state “multiply 108 times 3.” The user utterance is provided as an audio stream 306 to the speech support service server 302, which performs speech recognition and natural language understanding to determine the meaning of the user utterance. In response to the user utterance, the speech support service server 302 may calculate the desired calculation and instructs the construction tool 102 to display and/or speak out the result. In some cases, as mentioned above, the speech support service server 302 may conduct a two-directional speech dialog with the user to further refine the intent of the user, such as to determine the different measurements that should be multiplied. Upon fully defining the user intent, the speech support service server 302 instructs the construction tool 102 to perform the desired action.

In certain embodiments, the construction tool 102 may be configured to activate and utilize its own speech services 316 rather than the speech services of the speech support service server 302. In particular, the construction tool 102 may be configured to detect situations in which it is receiving external electrical power and may utilize one or more of its local speech services 316 in these situations.

In one example, the local speech services 316 may include a wakeword detection component 344. The wakeword detection component 344 may comprise a keyword detector that is configured to continuously monitor and audio signal from the microphone 106 to detect user utterances of a preselected keyword or wakeword, which is more generally referred to herein as a trigger expression. The trigger expression may comprise a keyword, a wakeword, an expression, a phrase, or some other sound or utterance that has been designated as indicating an intent by the user to direct speech to the construction tool 102. Such wakeword may include a power tool or hand tool brand such as “Stanley,” “Black & Decker,” “DeWalt,” “Porter-Cable,” “Craftsman,” “Irwin,” “Milwaukee,” “Ridgid,” “Makita,” “Hitachi,” “Metabo,” “Bosch,” “Skil,” “SkilSaw,” “Husky,” “Kobalt,” “Ryobi,” “Fein,” “Stihl,” “Husqvarna,” etc.

A wakeword may be customized for individual users in the form of a custom wakeword in place of a generic wakeword. For example, a wakeword can include phrases such as “Dan's tape” or “Rachel's miter saw.” Persons skilled in the art will recognize that providing individualized user wakewords to different construction tools 102, multiple devices can operate in a confined space independently without a wakeword triggering multiple devices.

Persons skilled in the art shall recognize that wakewords may be used to wake the device that do not require speech recognition . For example, construction tool 102 may be awoken in response to a whistle, clap or specific power tool noise that is recognized by construction tool 102.

The wakeword detection component 344 may be implemented using keyword spotting technology. A keyword spotter is a functional component or algorithm that evaluates an audio signal to detect the presence a predefined word or expression in the audio signal. Generally, a keyword spotter uses simplified ASR techniques to detect a specific word or a limited number of words rather than attempting to recognize a large vocabulary. For example, a keyword spotter may provide a notification when a specified word is detected in an audio signal, rather than providing a textual or word-based output. A keyword spotter using these techniques may compare different words based on hidden Markov models (HMMs), which represent words as series of states. Generally, an utterance is analyzed by comparing its model to a keyword model and to a background model. Comparing the model of the utterance with the keyword model yields a score that represents the likelihood that the utterance corresponds to the keyword. Comparing the model of the utterance with the background model yields a score that represents the likelihood that the utterance corresponds to a generic word other than the keyword. The two scores can be compared to determine whether the keyword was uttered.

In certain embodiments, audio may be streamed to the speech support service server 302 in response to either the talk button 110 being activated or in response to detection of the wakeword. In response to receiving the audio, the speech support service server 302 performs ASR and NLU to determine the meaning of the user speech and to determine an appropriate response.

In some embodiments, local wakeword detection may be used only when the construction tool 102 is connected to and receiving external power, such as when the construction tool 102 is placed in its power cable 204. When using wakeword detection, audio that is subsequent in time to the utterance of the wakeword is provided to the speech support service server 302. During times in which the construction tool 102 is operating from its internal rechargeable battery, without connection to external power, wakeword detection is disabled and audio is provided to the speech support service server only during times when the talk button 110 is pressed. Disabling the wakeword detection when operating from battery power reduces the computational load of the processor 310 and thereby reduces power consumption of the construction tool 102.

In some embodiments, the speech services 316 may also include ASR functionality 346. In some embodiments, the speech services 316 may also include NLU functionality 348. When these functionalities are present, they may be used in place of the corresponding functionalities provided by the speech support service server 302 during times when the construction tool 102 is receiving external power. Thus, rather than sending the audio signal 306 to the speech support service server 302, the construction tool 102 may perform ASR and/or NLU internally and may respond to user speech based on the internal or local analysis of captured audio. During times when the construction tool 102 is not connected to external power, audio may be sent to the speech support service server 302 for speech analysis, thereby reducing power consumption of the construction tool 102. The local ASR functionality 346 and NLU functionality 348 may use techniques similar to those used by the ASR service 334 and the NLU service 336 of the speech support service server 302.

Speech services 316 may also have the capability of recognizing the user's voice and using such recognition to provide additional security functionality. For example, construction tool 102 may allow User A to lock or unlock a tool box via a voice command, as the speech services 316 would recognize User A and confirm with other services that User A is authorized to lock or unlock the tool box. On the other hand, User B would not be able to lock or unlock the tool box, even though she may be authorized to interact with construction tool 102 and recognized by speech services 316, because she is not authorized to lock or unlock the tool box. Similarly, construction tool 102 may allow User B (but not User A) to change a value in a time sheet, as the speech services 316 would recognize User B and confirm with other services that User B is authorized to change a value in the time sheet.

In addition to wakeword detection, ASR, and NLU, the construction tool 102 may have other capabilities that are enabled only during those times when the construction tool 102 is receiving external power. Limiting usage of these capabilities to these times allows the construction tool 102 to conserve power and to prolong battery life.

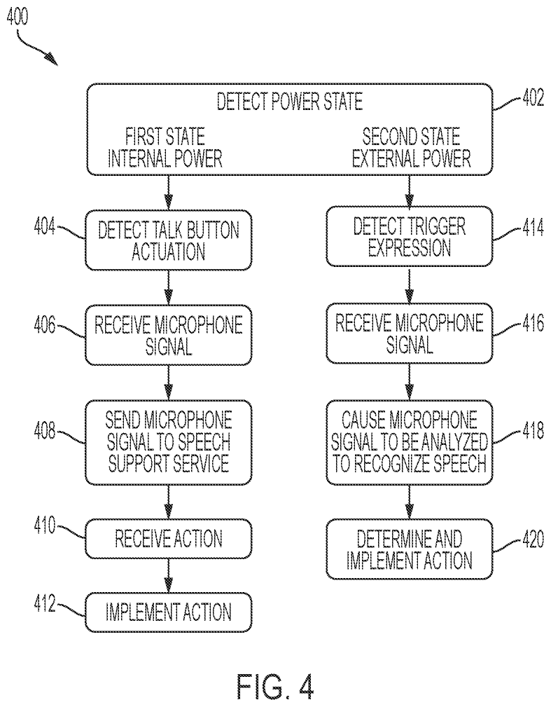

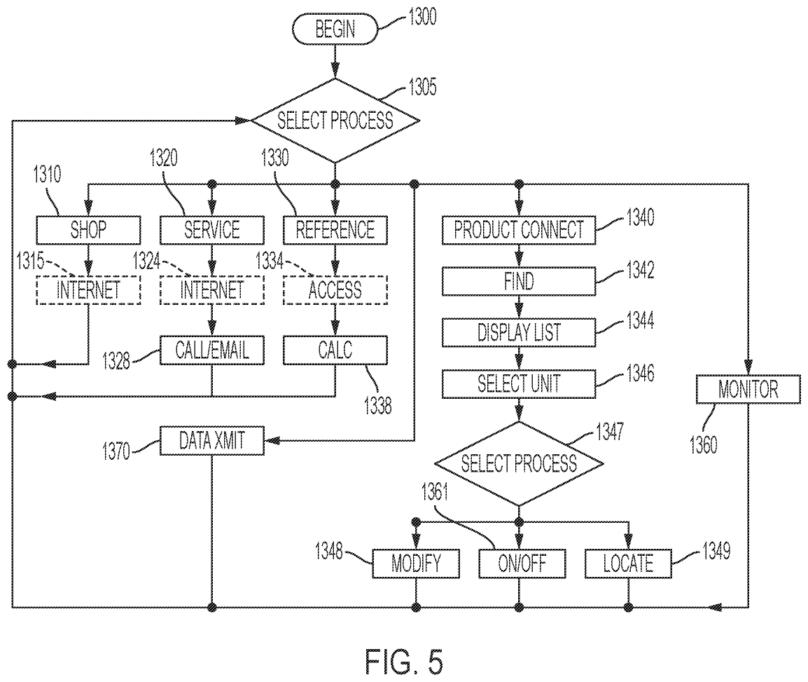

FIG. 4 shows an example method 400 that may be implemented by the construction tool 102 to interact with a user for playing audio content or performing other activities in response to spoken user commands. An action 402 detecting which of multiple power states the construction tool 502 is in. In the described implementation, there are two possible power states. The first power state comprises the state in which the construction tool 102 is operating solely from internal battery power and is not receiving external electrical power. The second power state comprises the state in which the construction tool 102 is receiving electrical power from a source external to the construction tool 102, other than the internal battery of the construction tool 102. Accordingly, the action 402, which may be performed by the power detector 322, comprises detecting whether the construction tool 102 is in the first power state or the second power state. Detecting that the construction tool 102 is in the first power state comprises determining that power is not being received from an external power source. Detecting that the construction tool 102 is in the second power state comprises determining that power is being received from an external power source.

In other embodiments, the power states may correspond to different conditions. For example, the first power state may correspond to a condition in which the internal battery of the construction tool 102 has a charge level that is below a selected threshold. For example, the first power state may correspond to the battery having a charge level below 10%. The second power state may correspond to a condition in which the internal battery of the construction tool 102 has a charge level that is above the selected threshold. For example, the second power state may correspond to the battery having a charge level above 10%.

Based on the power source available the device may adjust audio sampling rate, adjust LED brightness, increase or decrease wireless data rates, change wake up method, and/or change sleep time, etc.

The construction tool 102 operates in a first user interaction mode in response to detecting that the construction tool 102 is operating in the first power state. The construction tool 102 operates in a second user interaction mode in response to detecting that the construction tool 102 is in the second power state. A path along the left side of FIG. 4 is followed to implement the first user interaction mode. A path along the right side of FIG. 4 is followed to implement the second user interaction mode.

Operating in the first user interaction mode comprises the actions shown on the left side of FIG. 4. An action 404 comprises detecting actuation of the talk button 110. In response to actuation of the talk button 110, an action 406 is performed of receiving first speech input and generating first microphone audio data corresponding to the first speech input, using the microphone 106 of the construction tool 102. In operation, the user will speak while pressing the talk button, and the first microphone audio signal will therefore contain first user speech input that corresponds to a spoken user command. In some cases, the command may specify an action that is to be implemented by the construction tool 102, such as making an area calculation based on two measurements, making a purchase or playing a particular song.

An action 408 comprises sending the first microphone audio data to the speech support service server 302 for analysis, which may include ASR and NLU. For example, the speech support service server 302 may perform ASR and NLU to identify a song that the user has requested to be played by the construction tool 102. The first microphone audio data may be sent as a digital audio stream over the wide-area network 304 using the WiFi interface 326 of the construction tool. Persons skilled in the art will recognize that such digital audio stream can be sent over other networks, such as Bluetooth, cellular, etc.

An action 410 comprises receiving an indication from the speech support service server 302 of an action to be performed in response to the spoken user command. In some cases, the action 410 may comprise or may include receiving audio data corresponding to or representing a song that the user has requested to be played by the construction tool 102. For example, the construction tool 102 may communicate over the wide-area network 304 with a music service using the WiFi interface 326 to receive an audio signal from the music service, where the audio signal contains the song.

An action 412 comprises implementing the action indicated by the speech support service, such as by playing the song that has been identified based on the spoken user command. The song may be played using the speakers 108 of the construction tool 102.

Operating in the second user interaction mode comprises the actions shown on the right side of FIG. 4. An action 414 comprises detecting a user utterance of a trigger expression. For example, the construction tool may receive second speech input and may generate audio data representing or corresponding to the second user speech input. The wakeword detection component 344 may monitor the audio data to detect the user utterance of the trigger expression.

In response to detection of the user utterance of the trigger expression, an action 416 is performed of receiving third speech input and may generate audio data representing or corresponding to the third speech input. In use, the user will continue to speak after uttering the trigger expression, and the third audio data will therefore contain user speech input that corresponds to a second spoken user command. In some cases, the second command may specify another song that is to be played by the construction tool 102.

An action 418 may comprise causing the third audio data to be analyzed to recognize the third user speech and to determine a meaning or intent of the third user speech. In some cases, this may include identifying the song that the user has requested to be played.

In some implementations, causing the third audio data to be analyzed may comprise sending the third audio data to the speech support service server 302 over the wide-area network 304 using the WiFi interface 326 for analysis of the third audio data by the speech support service server 302. In other cases, causing the third audio data to be analyzed may comprise recognizing the user command using speech recognition and/or natural language understanding capabilities of the construction tool 102 itself.

An action 420 may comprise determining and implementing an action in response to the second user command. In some cases, the action 418 may comprise playing music or a song specified by the second user command. In some cases, the action 418 may comprise receiving audio data from a music service, where the audio data contains the music or song specified by the user command, and may additionally comprise rendering the audio signal to play the music.

Persons skilled in the art shall recognize that other user interaction modes can be used to provide a different user experience. For example, first user interaction mode may be modified to maintain construction tool 102 in a second user interaction mode for a period of time after talk button 110 is actuated and/or action 412 is implemented. This would allow construction tool 102 to respond to a wakeword rather than relying on a second talk button press.

Persons skilled in the art shall recognize that the construction tool 102 and the speech support service server 302 may be configured to interact according to a web services model. Generally, a web service may comprise any type of computing service that is made available to a requesting client via a request interface that includes one or more Internet-based application layer data transport protocols, such as a version of the Hypertext Transport Protocol (HTTP) or another suitable protocol.

Construction tool 102 may have additional features and functionalities. Persons skilled in the art are referred to U.S. Pat. No. 9,424,840 (entitled “Speech recognition platforms” and issued on Aug. 23, 2016), U.S. Pat. No. 9,558,740 (entitled “Disambiguation in speech recognition” and issued on Jan. 31, 2017) U.S. Pat. No. 9,633,661 (entitled “Speech-responsive portable speaker” and issued on Apr. 25, 2017), and U.S. Pat. No. 9,865,259 (entitled “Speech-responsive portable speaker” and issued on Jan. 9, 2018), which are hereby fully incorporated herein by reference.

Referring to FIG. 1, construction tool 102 may be part of a computer network 100 for a construction jobsite. The computer network 100 preferably includes a local router or server 101 disposed in the construction jobsite connected to the internet 304. Persons skilled in the art will recognize that local server 101 is preferably connected to the internet 304 via at least one of the following connections: digital subscriber lines (DSL), asymmetric digital subscriber lines (ADSL), symmetric digital subscriber lines (SDSL), very high digital subscriber lines (VDSL), cable-broadband internet connection, wireless broadband connection, T-1 lines, bonded T-1 lines, T-3 lines, optical carrier lines (OC3), internet over satellite (IoS), etc.

Construction tool 102 may be connectable to the local server 101 via a wired connection, such as an Ethernet network, and/or one or more of a variety of wireless technologies, including: wireless local area network (WLAN) technologies; wireless personal area network (WPAN) technologies (including low-rate wireless personal area network (LR-WPAN) technologies); radio frequency identification (RFID); ultra-wideband (UWB); ultrasound; Bluetooth, cellular, sound; infrared; visible light; camera vision, etc. Included in WLAN technologies are those conforming to the Institute of Electrical and Electronics Engineers (IEEE) 802.11 series of standards (e.g. Wi-Fi(™)), or custom protocols. Included in WPAN and LR-WPAN technologies are those conforming to the IEEE 802.15 series of standards (e.g. Bluetooth(™), ZigBee(™), etc.).

Such different wireless communication circuits allow construction tool 102 to communicate with different devices, such as computer 602, personal computing devices (such as tablets or smartphones 601), power tool 501, hand tool 502, and/or measuring tool 503, while preferably providing further features and advantages as described in US Patent Publication No. 2014/0107853, entitled “SYSTEM FOR ENHANCING POWER TOOLS,” which is hereby fully incorporated by reference. Persons skilled in the art will recognize that smartphones 601, power tool 501, hand tool 502, and/or measuring tool 503 may use more than one communication protocol to communicate with construction tool 102. For example smartphone 601 may communicate with construction tool 102 via a Bluetooth circuit and a WLAN/Wi-Fi circuit, etc. With such arrangement, information can be passed along between construction tool 102, smartphones 601, power tool 501, hand tool 502, and/or measuring tool 503 to a central server 103, which is connected to the internet 304.

Persons skilled in the art will recognize that construction tool 102 may transmit data to the repair/service center about construction tool 102, power tool 501, hand tool 502, and/or measuring tool 503, etc., such as cycle numbers, clutch activation count, current draw profiles, and other usage data. Such data can be obtained by the construction tool 102 querying power tool 501, hand tool 502, and/or measuring tool 503, etc., then receiving the data from the power tool 501, hand tool 502, and/or measuring tool 503, etc., and then forwarding the data to the repair/service center.

Similarly, construction tool 102 can transmit such data to other destinations, such as a supervisor's computing device, to alert the supervisor of a user's use or abuse of a construction tool 102, power tool 501, hand tool 502, and/or measuring tool 503, etc. Such data can be used to monitor the user's productivity.

Persons skilled in the art will recognize that the construction tool 102 could be used to record noises originating from power tool 501 and send those noises to the repair/service center for diagnosis of the power tool 501. The construction tool 102 could also analyze the noises and provide some troubleshooting advice for power tool 501 via display 112D.

If the user selects the reference process (step 1330), the construction tool 102 would access data stored in memory or stored in the internet (step 1334). Persons skilled in the art will recognize that the memory could be within or without construction tool 102. Such data could include reference materials, such as handbooks on different construction techniques, the different construction codes, such as the International Building Code, the International Residential Code, the International Plumbing Code, etc., as well as computer-aided design (CAD) data and/or building information modeling (BIM) data models of the worksite. The data could also include other executable routines, like calculator code for converting measurements between different units (e.g., converting feet to meters), calculating stair rise run, baluster spacing, roof pitches, HVAC calculations, etc., as well as different cost estimation tools, landscaping tools, etc.

The user can also choose to connect/pair to nearby power tools, battery packs or other products (step 1340). If such process is selected, construction tool 102 would proceed to wirelessly contact all nearby power tools, battery packs and other products (step 1342). Once contact has been made, construction tool 102 would display a list of nearby power tools, battery pack and other products (step 1344). Persons skilled in the art will recognize that construction tool 102 may connect to other power tools, battery packs or other products that are on the same network, even if they are not within pairing distance.

It may be preferable to color-code the different listed power tools, battery packs and other products. For example, tools that are owned (or paired) with the user can be shown in green. Tools that can't be contacted or accessed by the user can be shown in red. Tools that are owned by colleagues or a group are shown in yellow. Tools that have not been associated with a particular user can be shown in white. Alternatively, each power tool, battery pack, etc. may be shown with a specific color on the screen. Such power tool, battery pack, etc. may have a universal color-changing LED so that, if the user wants to locate the power tool marked with the yellow icon on the screen, the LED on the power tool would start flashing yellow, allowing the user to quickly find the correct power tool.

Similarly, persons skilled in the art will recognize that construction tool 102 may show a list of previously-paired power tools, power tool battery packs and other products, and show the ones that are nearby in one color, while showing the others in another color. In this manner, the user will know which power tools, power tool battery packs and other products are within a certain radius, thus conducting a quick inventory check.

The user can then select a particular power tool, battery pack or other item (step 1346). Once a particular item is selected, construction tool 102 can display different attributes for such product for review. For example, in the case of power tool 501, some of the attributes can include an identifying name (e.g., “Danny's Pack 1”), a picture icon, device model, the charge status, password (for accessing the tool information through another user's phone), temperature, number of charge cycles, etc. Persons skilled in the art will recognize that this information is kept in a memory within the item, which is then transmitted to construction tool 102, possibly upon a direct request from construction tool 102.

Persons skilled in the art will recognize that some of the attributes can be modified. For example, the identifying name and the picture icon can be modified by the user by selecting a modification process (steps 1347, 1348) and inputting the new information. This data can then be wirelessly transmitted to the power tool 501 or other item for storage within a memory (not shown). Persons skilled in the art will recognize that the user can input the new information (as well as other commands, etc.) via a keyboard or touchscreen 112T in construction tool 102 and/or by giving verbal commands which are recognized by the construction tool 102.

A user can modify data related to the performance of power tool 501 via construction tool 102. For example, the user may want to change a temperature threshold at which power tool 501 cut offs output power. In other words, rather than cutting off power when the power tool 501 has a temperature of 100°, the user may wish to change the cut off temperature to 110°.

To do so, the user may verbally input the desired cut off temperature into construction tool 102. Construction tool 102 wirelessly sends that data to power tool 501.

In such manner, power tool 501 may effectively be programmed to change different attributes or features. For example, a user can set the maximum motor speed or power, or provide a predetermined output (such as half the motor speed or power) when not within the vicinity of construction tool 102, etc. Similarly, it may be desirable to control any adjustable feature in a power tool 501 via construction tool 102. For example, the construction tool 102 may adjust output pressure in compressors, the amount of grease outputted by a grease gun when the trigger is pulled (persons skilled in the art will recognize that construction tool 102 can set a grease gun's pump to run for X pump cycles whenever the trigger is pulled; the higher the number of pump cycles per trigger pull, the larger the amount of grease outputted), the speed of a flywheel-based nailer (such as the one disclosed in U.S. Pat. No. 7,137,541, which is wholly incorporated herein by reference) in order to adjust for a different nail size or material in which the nail is being driven into, or a desired temperature for a heated jacket (such as the one disclosed in US Publication No. 2011/0108538, which is wholly incorporated herein by reference). Such data can be transmitted by construction tool 102 to power tool 501. The user may be required to press a button and/or pull a trigger on power tool 501 prior to altering or enacting the desired parameter.

The user may also request the construction tool 102 to announce when the associated power tool 501 has reached a particular and/or desired threshold. This announcement can be communicated via sound emitted by the construction tool 102 and/or by flashing LED(s) 112L and/or showing a message on display 112D.

The user can also request construction tool 102 to disable and/or enable the power tool 501, hand tool 502, and/or measuring tool 503 via construction tool 102. Persons skilled in the art will recognize that this can be accomplished by construction tool 102 sending an enabling/disabling instruction power tool 501, hand tool 502, and/or measuring tool 503. Persons skilled in the art will recognize that this could effectively function as a remote on/off switch (step 1361).

Furthermore, power tool 501 can store tool usage patterns, tool conditions, etc., which can be transmitted to construction tool 102 and to a server for further analysis, etc. As disclosed above, construction tool 102 can display such information. For example, construction tool 102 can display the speed (rpm), bevel angles, miter angles, brush wear, the presence or condition of a guard and/or attachment, etc. of the power tool 501.

The user can also enable and disable different modes of operation, such as allowing/not allowing power tool 501 to rotate in a reverse direction. As mentioned above, the user can enter such commands via buttons 112K or touchscreen 112T on construction tool 102 and/or by providing verbal commands recognized by construction tool 102.

Construction tool 102 may also be used to modify the different trigger profiles of power tool 501 as described in US Publication No. 2011/02544272, filed on Apr. 7, 2011, entitled “Power Tool Having a Non-Linear Trigger-Speed Profile,” which is hereby fully incorporated by reference. A user can use construction tool 102 to select between the different trigger profiles applicable to power tool 501. Such data would be sent to power tool 501, which would then save this instruction in a memory (not shown).

Other customizable features on power tools and other products may include the blink patterns of LEDs, the time period that an LED remains on after releasing a trigger switch, and/or audio beeping patterns for particular conditions in products with speakers or piezos, etc. The construction tool 102 can also turn on and off the power tool 501 or accessories thereof like a dust collector, open/close gates therein, etc.

If the power tool 501 has servos that can be used to adjust different features of power tool 501 (such as the miter saw disclosed in US Patent Publication No. 2001/0000856, filed on Jan. 5, 2001, and wholly incorporated herein by reference), the construction tool 102 can be used to adjust the different features by controlling the servos. For example, the user can request a bevel angle on the construction tool 102 and the construction tool 102 will control the bevel angle servo to the desired location. In this manner, the user can program a list of desired workpieces, i.e., a cut list, and the app can control the miter saw/power tool 501 to obtain those cuts. Similarly, the servos can be used to adjust the stroke length in a saw that allows for such adjustment, such as in reciprocating saws or jigsaws.

It may be beneficial to provide servos to perform functions that are difficult to do, like opening a blade clamp on a grinder or a recip saw. Rather than requiring the user to torque open a blade clamp, the user would request such operation from the construction tool 102.

Furthermore, a user can also use construction tool 102 to locate the selected power tool 501 or other product (step 1349). Construction tool 102 can send a command the selected power tool 501 or other product to start emitting a sound and/or light up or flash an LED.

The user can request construction tool 102 to monitor the power tool 501 and/or other products (step 1360). During this monitoring process, the construction tool 102 can keep track of power tool usage, present current draw, data received from sensors in the power tool 501 (for example pressure sensors disposed within the power tool 501), etc. and store and/or use that information for analysis by a service department. In this manner, the service department can determine whether a power tool 501 has been abused.

The construction tool 102 can use the monitored information to better utilize the power tool 501. For example, the construction tool 102 can receive PWM, voltage and/or current draw information from power tool 501 and establish a macro that would allow the user to repeat the current draw. Persons skilled in the art will recognize that such current draw profile can represent a torque curve for driving a fastener into a surface. Having a repeatable draw profile will allow the user to easily set a custom torque setting.

Construction tool 102 can monitor a particular parameter during an operation to determine whether an operation was successful. For example, construction tool 102 can monitor the motor current draw in power tool 501 during a crimping operation, as described in US Publication No. 2018/01360151, which is hereby fully incorporated by reference. If a crimp operation is not completed properly, construction tool 102 can announce that the crimp operation was not properly completed.

Persons skilled in the art will recognize that construction tool 102 can be used as a gateway for forwarding data and/or audio (step 1370). For example, construction tool 102 may be used as a VOIP terminal, sending audio data to the internet 304. Similarly, a user may request construction tool 102 to send an email or text message to a person or terminal. Such request would be interpreted by support service server 302 and acted upon accordingly.

It will be understood that the above description and the drawings are examples of particular implementations of the invention, but that other implementations of the invention are included in the scope of the claims.

The voice interaction may also be used to create a local or remotely (cloud based) stored list of items. This list of items may be stored in a local or remote database. These items may be categorized into specific database fields which the user may specify using keywords such as “window” or “door” to describe the type of item or measurement that may follow. The list or database may automatically categorize these items based on context or recently used keywords. The user may also have the ability to set the context for a group of items using a keyword. The categories in the database may be pre-defined fields or the fields may be automaticsally added from the transcribed audio.

The user may be able to share the database or list with another user's device, email, website, file share etc. To share the database or a list the user would use a voice command such as “Share my list with Dan” or share a part of the list or database using a voice command such as “share my window list with Dan”. The database of list may also be linked to several devices such that as one device records a new item into the database the information displayed or spoken on other device is also updated.

The user may also be able search the list or database using keywords. When a search is conducted the local display will display the relevant results.

The database may also be a simple tree structure wherein a root category may contain subcategories which may contain additional sub categories and so on.

What is claimed is:

1: A construction tool comprising a housing;
a processor disposed within the housing;
a microphone disposed within the housing, the microphone capturing speech uttered by a user;
speech services module connected to the processor for interpreting the speech, the speech services module providing instructions to the processor in response to the interpreted speech; and
a speaker disposed within the housing;
wherein the construction tool is electrically connectable to at least one of a power tool, a hand tool, and a non-motorized sensing tool.

2: The construction tool of claim 1, wherein the speech services module is disposed within the housing.

3: The construction tool of claim 1, further comprising a wireless communications interface configured to communicate over a wide-area network.

4: The construction tool of claim 3, wherein the speech services module is located in a remote server accessed via the wireless communications interface.

5: The construction tool of claim 1, further comprising a talk button.

6: The construction tool of claim 5, wherein the construction tool being configured to detect actuation of the talk button, capturing the speech, analyzing the captured speech conducted by the speech services module and instructing the processor based on the analyzed speech.

7: The construction tool of claim 1, further comprising a display.

8: The construction tool of claim 1, wherein the construction tool provides data to the at least one of a power tool, a hand tool, and a non-motorized sensing tool when connected to the at least one of a power tool, a hand tool, and a non-motorized sensing tool.

9: The construction tool of claim 1, wherein the construction tool receives data from the at least one of a power tool, a hand tool, and a non-motorized sensing tool when connected to the at least one of a power tool, a hand tool, and a non-motorized sensing tool.

10: The construction tool of claim 1, further comprising a power detector configured to detect a first power state and a second power state of the construction tool.

11: The construction tool of claim 10, being configured to operate in a first mode when in the first power state and a second mode when in the second power state;
wherein operating in the first mode comprises: detecting actuation of the talk actuator; generating, based at least in part on the actuation of the talk actuator, first audio data corresponding to first speech input; sending the first audio data to a speech support service server that is external to the construction tool; receiving second audio data from the speech support service server,
wherein the second audio data is based at least in part on the first audio data; and outputting audible content corresponding to the second audio data; and
wherein operating in the second mode comprises: receiving second speech input; generating third audio data corresponding to the second speech input; and analyzing the third audio data.

12: The construction tool of claim 11, wherein operating in the second mode further comprises: detecting, based at least in part on analyzing the third audio data, utterance of a trigger expression; receiving third speech input;
generating fourth audio data using the microphone, the fourth audio data corresponding to the third speech input; and causing the claim 13: The construction tool of claim 12, wherein causing the fourth audio data to be analyzed comprises sending the fourth audio data to the speech support service server.

14: The construction tool of claim 11, wherein the first power state indicates that the construction tool is not receiving power from an external power source; and
the second power state indicates that the construction tool is receiving power from an external power source.

15: The construction tool of claim 11, wherein operating in the first mode further comprises receiving an indication from the speech support service server of a first action to perform in response to the first speech input; and
operating in the second mode further comprises determining, by the construction tool, a second action to perform in response to the second speech input.

16: The construction tool of claim 11, wherein sending the first audio data to the speech support service server comprises sending the first audio data over a wide-area network to the speech support service server, wherein the speech support service server is configured to perform automatic speech recognition and natural language understanding.

17: The construction tool of claim 11, further comprising a wireless network interface configured to communicate with the speech support service server.

18: The construction tool of claim 11, wherein operating the construction tool in the second mode further comprises: detecting an utterance of a trigger expression in the second speech input; and generating fourth audio data corresponding to third speech input based at least in part on detecting the utterance of the trigger expression.
